(19) United States
(12) Patent Application Publication
(10) Pub. No.: US 2009/0169327 A1
(43) Pub. Date: Jul. 2, 2009

(54) Weldable nut assembly

(75) Inventor: Rong-Bin Wu, Tainan County (TW)

Correspondence Address: Haynes and Boone, LLP;IP Section, 2323 Victory Avenue, SUITE 700, Dallas, TX, 75219, US

(73) Assignee: BOLTUN CORPORATION

(21) Appl. No.: 12/082,397

(22) Filed: Apr. 10, 2008

(30) Foreign Application Priority Data
Dec. 26, 2007 (TW) 096150259

(51) Int. Cl. F16B 37/06; F16B 37/04

(52) U.S. Cl. 411/106; 411/171

(57) ABSTRACT

A weldable nut assembly includes a plate body and a nut body. The plate body has top and bottom sides, and is formed with an installation hole, and a plurality of welding portions that protrude from the bottom side of the plate body. The nut body includes a nut portion that abuts against the top side of the plate body and that is in spatial communication with the installation hole, an upper annular flange that abuts against the top side of the plate body, and a lower annular flange that extends downwardly and coaxially from a bottom side of the nut portion, that extends into the installation hole, and that is machined so as to abut against the plate body. The lower annular flange has a plurality of teeth that abut against the plate body and that cooperate with the upper annular flange for clamping the plate body therebetween.

### BACKGROUND OF THE INVENTION

1. Field of the Invention

This invention relates to a nut assembly, more particularly to a weldable nut assembly that can withstand a high degree of torsion.

2. Description of the Related Art

A conventional weldable nut assembly 1, as shown in FIGS. 1 and 2, includes a plate body 11, and a nut body 12 that is coupled to the plate body 11. The plate body 11 is formed with a through-hole 110, and a plurality of welding portions 111 protruding from a bottom side thereof. The nut body 12 includes a nut portion 121 that abuts against a top side of the plate body 11, an upper annular portion 122 extending radially and outwardly from a periphery of the nut portion 121 and abutting against the top side of the plate body 11, and a lower annular portion 123 extending downwardly from the nut portion 121 into the through-hole 110 and that is anchored to the plate body 11. Accordingly, the nut body 12 is coupled to the plate body 11 through clamping provided by the upper and lower annular portions 122, 123. However, one problem associated with the structure of the nut assembly 1 is that the upper and lower annular portions 122, 123 of the nut body 12 are solely designed to clamp the plate body 11 and are not designed to resist torsion that may arise during threaded engagement with a bolt (not shown). As such, the nut body 12 may rotate relative to the plate body 11, which hinders tightening of the bolt.

### SUMMARY OF THE INVENTION

It is an object of the present invention to provide a weldable nut assembly that can overcome the above drawback of the prior art.

According to the present invention, a weldable nut assembly includes a plate body and a nut body. The plate body has top and bottom sides, and is formed with an installation hole that extends through the top and bottom sides, and a plurality of welding portions that are spaced apart from each other and that protrude from the bottom side of the plate body. The nut body includes a nut portion that abuts against the top side of the plate body and that is in spatial communication with the installation hole, an upper annular flange that extends radially and outwardly from the nut portion and that abuts against the top side of the plate body, and a lower annular flange that extends downwardly and coaxially from a bottom side of the nut portion, that extends into the installation hole, and that is machined so as to abut against the plate body. The lower annular flange has a plurality of teeth that abut against the plate body and that cooperate with the upper annular flange for clamping the plate body therebetween.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional weldable nut assembly;

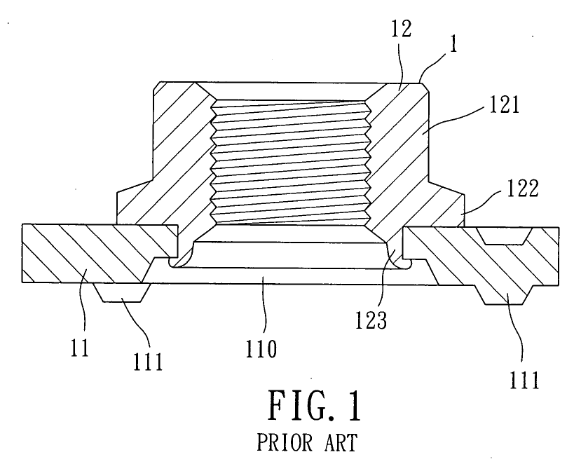

FIG. 2 is an exploded view of the weldable nut assembly shown in FIG. 1;

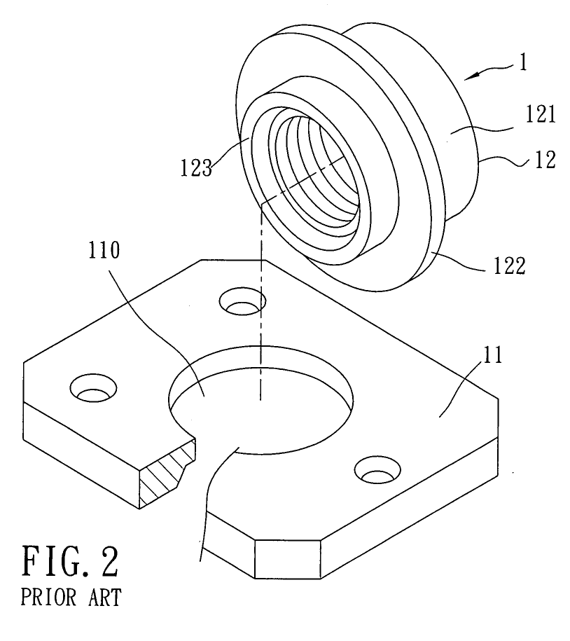

FIG. 3 is a an assembled view of the preferred embodiment of a weldable nut assembly according to the present invention;

FIG. 4 is an exploded perspective view of the preferred embodiment shown in FIG. 3; and

FIG. 5 is a sectional view of the preferred embodiment.

### DETAILED DESCRIPTION OF THE PREFERRED EMBODIMENT

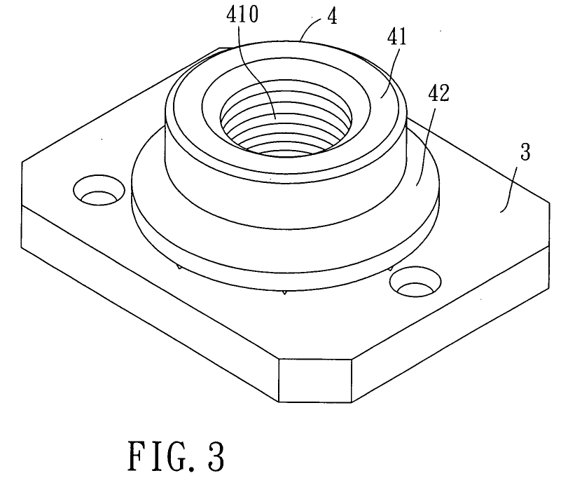

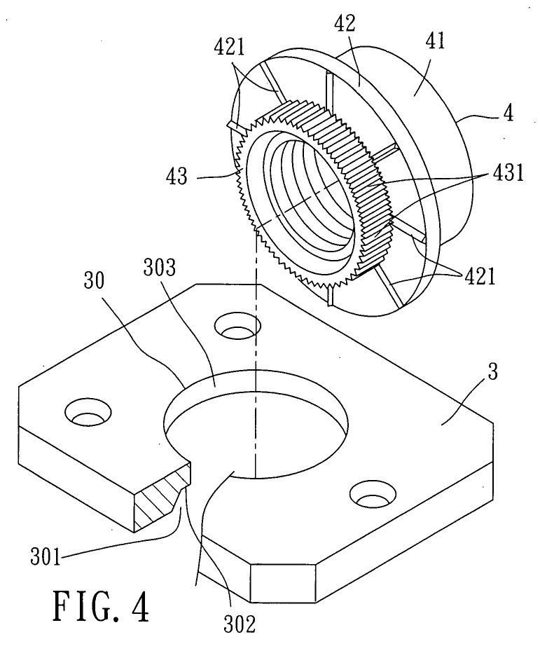

Referring to FIGS. 3 to 5, the preferred embodiment of a weldable nut assembly according to the present invention includes a plate body 3 and a nut body 4. The plate body 3 has top and bottom sides, and is formed with a circular installation hole 30 that extends through the top and bottom sides, and a plurality of welding portions 31 that are spaced apart from each other and that protrude from the bottom side of the plate body 3. The nut body 4 includes a nut portion 41 that abuts against the top side of the plate body 3 and that is in spatial communication with the installation hole 30, an upper annular flange 42 that extends radially and outwardly from the nut portion 41 and that has a bottom side formed with a plurality of positioning ribs 421 for abutting against the top side of the plate body 3, and a lower annular flange 43 that extends downwardly and coaxially from a bottom side of the nut portion 41, that extends into the installation hole 30, and that is machined (such as by press rolling) so as to abut against the plate body 3. The lower annular flange 43 has a plurality of teeth 431 that abut against the plate body 3 and that cooperate with the positioning ribs 421 of the upper annular flange 42 for clamping the plate body 3 therebetween. The nut portion 41 has an internally threaded bore 410 for threaded engagement with a fastener, such as a bolt or screw. The positioning ribs 421 extend in radial outward directions with respect to an axis of the upper annular flange 42 and are angularly spaced apart from each other. The teeth 431 also extend in radial outward directions with respect to an axis of the lower annular flange 43 and are angularly spaced apart from each other.

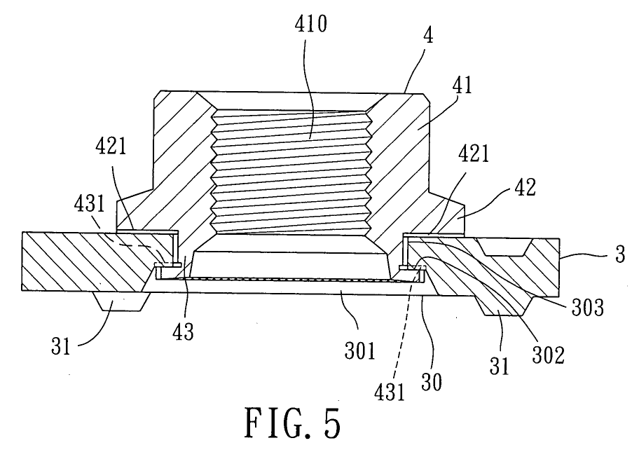

In this embodiment, the installation hole 30 includes a larger-diameter portion 301 that is indented from the bottom side of the plate body 3, a smaller-diameter portion 303 that is indented from the top side of the plate body 3 and that has a diameter smaller than that of the larger-diameter portion 301, and a shoulder portion 302 at a junction of the larger-diameter and smaller-diameter portions 301, 303. As best shown in FIG. 5, the lower annular flange 43 of the nut body 4 extends downwardly through the smaller-diameter portion 303 into the larger-diameter portion 301. The teeth 431 of the lower annular flange 43 are embedded in the shoulder portion 302.

When assembling the nut body 4 onto the plate body 3, the lower annular flange 43 of the nut body 4 is first inserted downwardly into the installation hole 30 so that the bottom side of the nut portion 41 and the positioning ribs 421 of the upper annular flange 42 abut against the top side of the plate body 3. Next, from a bottom side of the plate body 3 where the lower annular flange 43 is exposed by the larger-diameter portion 301, the lower annular flange 43 is machined (e.g. by press rolling), so that the teeth 431 are embedded in the shoulder portion 302. Accordingly, the plate body 3 is clamped securely, through the gripping engagement, between the positioning ribs 421 of the upper annular flange 42 and the teeth 431 of the lower annular flange 43.

It has thus been shown that, due to the presence of the positioning ribs 421 that abut against the top side of the plate body 3, together with the teeth 431 that are embedded in the shoulder portion 302, the nut body 4 is firmly mounted onto the plate body 3. As such, resistance to rotation of the nut body 4 relative to the plate body 3 is increased, and the coupling strength between the plate and nut bodies 3,4 is increased as well. In short, the plate body 3 and the nut body 4 are no longer prone to rotate relative to each other.

It should be noted that the present invention is not limited to the aforesaid preferred embodiment. Even if the positioning ribs 421 are not formed on the upper annular flange 42, the weldable nut assembly can similarly attain the aforementioned advantages of the preferred embodiment. That is, by using only the teeth 431 and the upper annular flange 42 (without the positioning ribs 421) to clamp the plate body 3 therebetween, the aforementioned advantages can still be realized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A weldable nut assembly comprising:
a plate body having top and bottom sides and formed with an installation hole that extends through said top and bottom sides, and a plurality of welding portions that are spaced apart from each other and that protrude from said bottom side of said plate body; and
a nut body including a nut portion that abuts against said top side of said plate body and that is in spatial communication with said installation hole, an upper annular flange that extends radially and outwardly from said nut portion and that abuts against said top side of said plate body, and a lower annular flange that extends downwardly and coaxially from a bottom side of said nut portion, that extends into said installation hole, and that is machined so as to abut against said plate body, said lower annular flange having a plurality of teeth that abut against said plate body and that cooperate with said upper annular flange for clamping said plate body therebetween.

2. The weldable nut assembly as claimed in claim 1, wherein said installation hole includes a larger-diameter portion that is indented from said bottom side of said plate body, a smaller-diameter portion that is indented from said top side of said plate body and that has a diameter smaller than that of said larger-diameter portion, and a shoulder portion at a junction of said larger-diameter and smaller-diameter portions, said lower annular flange of said nut body extending downwardly through said smaller-diameter portion, said teeth of said lower annular flange being embedded in said shoulder portion.

3. The weldable nut assembly as claimed in claim 1, wherein said upper annular flange has a bottom side formed with a plurality of positioning ribs that abut against said plate body.

4. The weldable nut assembly as claimed in claim 2, wherein said upper annular flange has a bottom side formed with a plurality of positioning ribs that abut against said plate body.

5. The weldable nut assembly as claimed in claim 4, wherein said positioning ribs extend in radial outward directions with respect to an axis of said upper annular flange and are angularly spaced apart from each other, and said teeth extend in radial outward directions with respect to an axis of said lower annular flange and are angularly spaced apart from each other.
